(19) United States
(12) Patent Application Publication
(10) Pub. No.: US 2013/0134207 A1
(43) Pub. Date: May 30, 2013

(54) SOLDER BUMP FORMING APPARATUS AND SOLDERING FACILITY INCLUDING THE SAME

(71) Applicant: Samsung Electro-Mechanics Co., Ltd., Suwon (KR)

(72) Inventors: Noriaki MUKAI, Suwon (KR); Hueng Jae OH, Suwon (KR); Jin Won CHOI, Yongin (KR)

(73) Assignee: Samsung Electro-Mechanics Co., Ltd., Suwon (KR)

(21) Appl. No.: 13/675,227

(22) Filed: Nov. 13, 2012

(30) Foreign Application Priority Data
Nov. 29, 2011 (KR) 10-2011-0125897

(51) Int. Cl. B23K 3/06

(52) U.S. Cl. CPC B23K 3/0623
USPC 228/33

(57) ABSTRACT

Disclosed herein is a solder bump forming apparatus including: a flux dispenser dispensing a flux to a processing substrate; a solder dispenser dispensing a solder to the processing substrate to which the flux is applied while moving following the flux dispenser; and driver driving the flux dispenser and the solder dispenser.

### CROSS REFERENCE(S) TO RELATED APPLICATIONS

This application claims the benefit under 35 U.S.C. Section 119 of Korean Patent Application Serial No. 10-2011-0125897, entitled “Solder Bump Forming Apparatus and Soldering Facility Including the Same” filed on Nov. 29, 2011, which is hereby incorporated by reference in its entirety into this application.

### BACKGROUND OF THE INVENTION

1. Technical Field

The present invention relates to a solder bump forming apparatus and a soldering facility including the same, and more particularly, to a solder bump forming apparatus capable of effectively forming a solder bump with respect to a fine-pitched circuit board, and a soldering facility including the same.

2. Description of the Related Art

A process of manufacturing a printed circuit board (PCB) generally includes a process of forming a solder bump on an electrode pad formed on a substrate. The process of forming a solder bump as described above is typically performed using a squeeze soldering method, a wave soldering method, and the like.

In the squeeze soldering method, a solder bump is formed by closely adhering a screen mask to a substrate so that an electrode pad formed on the substrate is selectively exposed, applying a predetermined amount of solder onto the screen mask, and then allowing the solder to selectively contact the electrode pad through the screen mask while squeezing the screen mask using a plate called a squeeze. In the wave soldering method, a solder bump is formed by preparing a solder bath filled with a solder and then allowing the solder in the solder bath to contact an electrode pad of a substrate having a protection pattern formed thereon so that the electrode pad is selectively exposed on the solder bath while transferring the substrate.

However, in the case of the soldering methods as described above, it is difficult to form effectively form a solder bump with respect to a significantly fine-pitched circuit board.

### RELATED ART DOCUMENT

### Patent Document

(Patent Document 1) Japanese Patent Laid-open Publication No. 2007-242874

### SUMMARY OF THE INVENTION

An object of the present invention is to provide a solder bump forming apparatus capable of effectively forming a solder bump, and a soldering facility including the same.

An object of the present invention is to provide a solder bump forming apparatus capable of effectively forming a solder bump with respect to a fine-pitched circuit board, and a soldering facility including the same.

According to an exemplary embodiment of the present invention, there is provided a solder bump forming apparatus including: a flux dispenser dispensing a flux to a processing substrate; a solder dispenser dispensing a solder to the processing substrate to which the flux is applied while moving following the flux dispenser; and driver driving the flux dispenser and the solder dispenser.

The flux dispenser may include a first temperature controller heating the flux to a preset active temperature. A heating or cooling temperature of the first temperature controller may be 140 to 210° C.

The solder dispenser may include a second temperature controller heating the solder to a preset temperature, and a heating temperature of the second temperature controller maybe controlled so as to satisfy an active temperature of the flux in the flux dispenser as well as melt the solder.

The heating temperature of the second temperature controller may be 170 to 230° C.

The solder bump forming apparatus may further include a heat insulator provided between the flux dispenser and the solder dispenser to block heat of the solder dispenser from being transferred to the flux dispenser.

The solder bump forming apparatus may further include a discharger discharging a flux vaporized on the processing substrate to the outside between the flux dispenser and the solder dispenser.

The discharger may include a discharging line connected to a discharging space provided between the flux dispenser and the solder dispenser to suck the vaporized flux in the discharging space.

The flux dispenser may be provided integrally with the solder dispenser, and the driver may move the flux dispenser and the solder dispenser so that the solder dispenser moves following the flux dispenser at the time of the soldering process.

According to another exemplary embodiment of the present invention, there is provided a soldering facility including: a substrate supporting apparatus supporting a processing substrate; and a solder bump forming apparatus performing a soldering process on the processing substrate supported by the substrate supporting apparatus, wherein the solder bump forming apparatus includes: a flux dispenser dispensing a flux to the processing substrate; a solder dispenser dispensing a solder to the processing substrate to which the flux is applied while moving following the flux dispenser; and driver driving the flux dispenser and the solder dispenser.

The substrate supporting apparatus may transfer the processing substrate so that a processing surface of the processing substrate is directed upwardly, and the solder bump forming apparatus may sequentially and downwardly dispense the flux and the solder onto the processing substrate while moving horizontally over the substrate supporting apparatus.

The soldering facility may further include a protection pattern attaching device attaching a protection pattern selectively exposing an electrode pad formed on a circuit board to a processing surface of the circuit board.

The flux dispenser may include a first temperature controller heating the flux to a preset active temperature.

The solder dispenser may include a second temperature controller heating the solder to a preset temperature, and a heating temperature of the second temperature controller may be controlled so as to satisfy an active temperature of the flux in the flux dispenser as well as melt the solder.

The flux dispenser and the solder dispenser may be disposed to be spaced apart from each other by a predetermined interval, and a space between the flux dispenser and the solder dispenser may be used as a discharging path discharging the flux volatilized on the processing substrate as well as preventing heat of the solder dispenser from being excessively transferred to the flux dispenser.

The flux dispenser may be provided integrally with the solder dispenser, and the driver may move the flux dispenser and the solder dispenser so that the solder dispenser moves following the flux dispenser at the time of the soldering process.

### BRIEF DESCRIPTION OF THE DRAWINGS

FIG. 1 is a view showing a soldering facility according to an exemplary embodiment of the present invention; and

FIG. 2 is a view showing a detailed configuration of the solder bump forming apparatus shown in FIG. 1.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a solder bump forming apparatus and a soldering facility including the same according to an exemplary embodiment of the present invention will be described in detail.

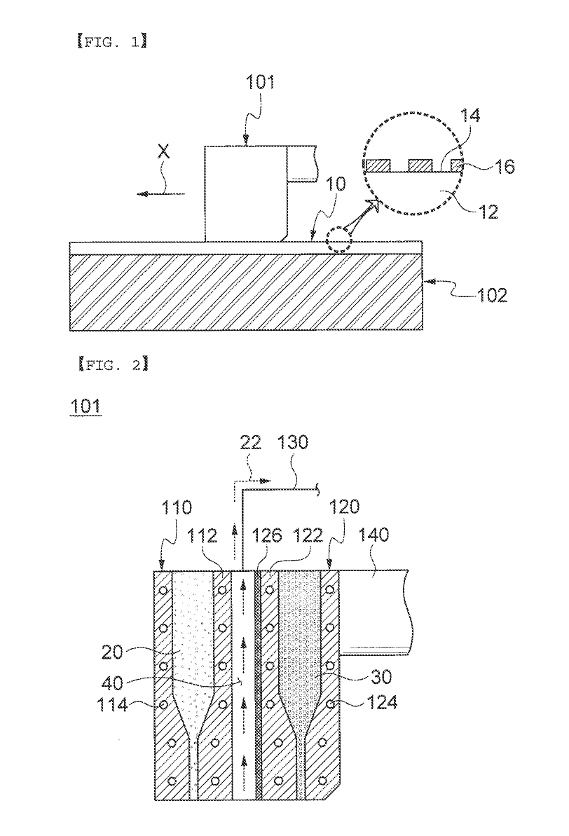

FIG. 1 is a view showing a soldering facility according to an exemplary embodiment of the present invention; and Referring to FIG. 1, the soldering facility 100 according to the exemplary embodiment of the present invention may include a solder bump forming apparatus 101 and a substrate supporting apparatus 102.

The solder bump forming apparatus 101 may perform a soldering process on a predetermined processing substrate 10. The soldering process may be a process of forming a solder bump on the processing substrate 10, which is a printed circuit board (PCB).

The substrate supporting apparatus 102 may support the processing substrate 10 under the solder bump forming apparatus 101 at the time of the soldering process. The substrate supporting apparatus 102 may support the processing substrate 10 so that a processing surface of the processing substrate 10 is directed upwardly. The substrate supporting apparatus 102 may support the processing substrate 10 by mechanically holding or clamping the processing substrate 10 or support in a vacuum adsorption scheme.

Meanwhile, the processing substrate 10 may be a structure in which a protection pattern 16 selectively exposing an electrode pad 14 of a circuit board 12 with respect to the circuit board 12 is formed. To this end, the soldering facility 100 may further include a protection pattern attaching device (not shown) for forming the protection pattern 16 on the circuit substrate 10. The protection pattern attaching device may be a device attaching a dry film on the circuit board 10. Alternatively, the protection pattern attaching device may be a device attaching a polymer mask on the circuit board 10.

The soldering facility 100 having the above-mentioned structure may be a so called molten soldering process facility in which the solder bump forming apparatus 101 is disposed over the substrate supporting apparatus 102 and a soldering process is performed on the processing substrate 10 supported by the substrate supporting apparatus 102.

Next, the solder bump forming apparatus according to the exemplary embodiment of the present invention will be described in detail.

FIG. 2 is a view showing a solder bump forming apparatus according to the exemplary embodiment of the present invention. Referring to FIG. 2, the solder bump forming apparatus 101 according to the exemplary embodiment of the present invention may include a flux dispenser 110, a solder dispenser 120, a discharger 130, and a driver 140.

The flux dispenser 110 may dispense a flux 20 to the processing substrate 10. The flux dispenser 110 may include a first body 112 and a first temperature controlling member 114. The first body 112 may have a flux receiving space receiving the flux 20 therein. The first temperature controlling member 114 may be provided in the first body 112 and heat or cool the flux 20 in the flux receiving space to a preset active temperature. For example, the active temperature of the flux 20 may be in a range of approximately 140 to 210° C. The first temperature controlling member 114 may set a heating or cooling temperature thereof so that the flux 20 in the flux receiving space is maintained in the above-mentioned temperature range. Therefore, the flux 20 may stand ready to be supplied in the flux receiving space in a state in which it is activated, and be dispensed to the processing substrate 10 through a lower outlet of the first body 112 at the time of the soldering process.

The solder dispenser 120 may dispense a solder to the processing substrate 10. The solder dispenser 10 may include a second body 122 and a second temperature controlling member 124. The second body 122 may have a solder receiving space receiving the solder 30 therein. The second temperature controlling member 124 may be provided in the second body 122 and heat the solder 30 in the solder receiving space to a preset heating temperature. For example, since the solder 30 is molten in a range of approximately 170 to 230° C. according to a kind thereof, the second temperature controlling member 124 may set a heating temperature thereof so that the solder 30 in the solder receiving space is heated to the above-mentioned temperature range. Therefore, the solder 30 may stand ready to be supplied in the solder receiving space in a state in which it is molten, and be dispensed to the processing substrate 10 through a lower outlet of the second body 122 at the time of the soldering process.

As described above, the heating temperature of the second temperature controlling member 124 provided in the solder dispenser 120 may be relatively higher than that of the first temperature controlling member 114. Therefore, due to the relatively high heating temperature of the second temperature controlling member 124, in the case in which the flux 20 is heated in excess of an active temperature range, active efficiency of the flux 20 may be reduced. In order to prevent the reduction in active efficiency of the flux 20, a heat insulator 126 preventing the heat of the solder dispenser 120 from being transferred to the flux dispenser 110 may be provided. The heat insulator 126 may be provided at one side of the solder dispenser 120 facing the flux dispenser 110 to prevent the heat of the second temperature controlling member 124 to the flux dispenser 110. Alternatively, the heat insulator 126 may also be provided at one side of the flux dispenser 110 facing the solder dispenser 120.

The discharger 130 may discharge a vaporized flux 22 to the outside at the time of the soldering process. More specifically, the flux 20 dispensed onto the processing substrate 10 by the flux dispenser 110 may be partially vaporized by an ambient temperature. In the case in which the flux 22 vaporized as described above is not discharged to the outside, it remains between the processing substrate and the dispensers 110 and 120. This remaining flux 22 may subsequently act as a factor hindering the solder 30 from effectively entering the electrode pad 14 of the circuit board 12, thereby reducing soldering process efficiency. In order to prevent this, the vaporized flux 22 between the flux dispenser 110 and the solder dispenser 120 needs to be discharged to the outside. Therefore, a discharging space 40 for discharging the vaporized flux 22 may be provided between the flux dispenser 110 and the solder dispenser 120, and the discharger 130 may include a discharging line discharging the vaporized flux 22 from the discharging space 40 to the outside. The discharging line may be provided with a suction device (not shown) for providing suction pressure to the discharging space 40.

The driver 140 may drive the flux dispenser 110 and the solder dispenser 120. For example, the driver 140 may move the dispensers 110 and 120 horizontally in a first direction X. Here, the flux dispenser 110 and the solder dispenser 120 may be provided integrally with each other. That is, the flux dispenser 110 and the solder dispenser 120 may be configured to be coupled to each other to thereby be driven and move together with each other. In this case, the driver 140 may move a structure configured of the dispensers 110 and 120 by moving any one of the dispensers 110 and 120.

Meanwhile, when the flux dispenser 110 and the solder dispenser 120 move in the first direction X at the time of the soldering process, the solder dispenser 120 may move following the flux dispenser 110. In this case, at the time of the soldering process, the flux dispenser 110 may first dispense the flux 20 to the processing substrate 10 in front of the solder dispenser 120, and the solder dispenser 120 may dispense the solder 30 to the processing substrate 10 to which the flux 20 is dispensed behind the flux dispenser 100.

Although a case in which each of the first and second temperature controlling members 114 and 124 is provided in the dispensers 110 and 120 has been described in the exemplary embodiment of the present invention described above by way of example, a scheme of maintaining the flux 20 and the solder 30 in a preset temperature may be variously changed and varied. For example, as another example of the present invention, the temperatures of the flux 20 and the solder 30 may be controlled only by the second temperature controlling member 124. More specifically, since the heating temperature of the second temperature controlling member 124 is relatively higher than that of the first temperature controlling member 114, the second temperature controlling member 124 may set the heating temperatures so as to satisfy the active temperature of the flux 20 as well as the preset heating temperature of the solder 30, without the first temperature controlling member 114. To this end, the discharging space 40 may be designed to serve to lower the heating temperature of the second temperature controlling member 124 to the active temperature of the flux 20. Alternatively, as still another example of the present invention, the first temperature controlling member 114 may be used as a cooler lowering a temperature of the flux receiving space in consideration of the heating temperature of the second temperature controlling member 124.

As described above, the solder bump forming apparatus 101 according to the exemplary embodiment of the present invention may include the flux dispenser 110 dispensing the flux 20 onto the processing substrate 10 and the solder dispenser 120 dispensing the solder 30 onto the processing substrate 10 while following the flux dispenser 110, at the time of the soldering process. Therefore, the solder bump forming apparatus and the soldering facility including the same according to the exemplary embodiment of the present invention continuously batches a flux processing process and a solder processing process, thereby making it possible to improve the soldering process efficiency.

The solder bump forming apparatus 101 to the exemplary embodiment of the present invention may include the flux dispenser 110 and the solder dispenser 120 provided integrally with each other and the discharger 130 provided between the flux dispenser 110 and the solder dispenser 120 to discharge the flux 22 vaporized on the processing substrate 10 at the time of the soldering process to the outside. Therefore, the solder bump forming apparatus and the soldering facility including the same according to the exemplary embodiment of the present invention dispenses the solder in a state in which the flux vaporized on he processing substrate at the time of the soldering process is discharged to the outside to allow the solder to effectively enter the electrode pad of the processing substrate, thereby making it possible to improve the soldering process efficiency.

In addition, the solder bump forming apparatus 101 according to the exemplary embodiment of the present invention may include the flux dispenser 110 and the solder dispenser 120 provided integrally with each other and the temperature controlling member provided in at least one of the dispensers 110 and 120 so as to satisfy both of the active temperature of the flux 20 and the melting temperature of the solder 30. Therefore, the solder bump forming apparatus and the soldering facility including the same according to the exemplary embodiment of the present invention continuously batches the flux processing process and the solder processing process while satisfying both of the active temperature of the flux and the preset heating temperature of the solder, thereby making it possible to improve the soldering process efficiency.

As set forth above, the solder bump forming apparatus and the soldering facility including the same according to the exemplary embodiment of the present invention continuously batches a flux processing process and a solder processing process, thereby making it possible to improve the soldering process efficiency.

The solder bump forming apparatus and the soldering facility including the same according to the exemplary embodiment of the present invention dispenses the solder in a state in which the flux vaporized on he processing substrate at the time of the soldering process is discharged to the outside to allow the solder to effectively enter the electrode pad of the processing substrate, thereby making it possible to improve the soldering process efficiency.

The solder bump forming apparatus and the soldering facility including the same according to the exemplary embodiment of the present invention continuously batches the flux processing process and the solder processing process while satisfying both of the active temperature of the flux and the preset heating temperature of the solder, thereby making it possible to improve the soldering process efficiency.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

1. A solder bump forming apparatus comprising:
a flux dispenser dispensing a flux to a processing substrate;
a solder dispenser dispensing a solder to the processing substrate to which the flux is applied while moving following the flux dispenser; and
driver driving the flux dispenser and the solder dispenser.

2. The solder bump forming apparatus according to claim 1, wherein the flux dispenser includes a first temperature controller heating the flux to a preset active temperature.

3. The solder bump forming apparatus according to claim 2, wherein a heating or cooling temperature of the first temperature controller is 140 to 210° C.

4. The solder bump forming apparatus according to claim 1, wherein the solder dispenser includes a second temperature controller heating the solder to a preset temperature, and
a heating temperature of the second temperature controller is controlled so as to satisfy an active temperature of the flux in the flux dispenser as well as melt the solder.

5. The solder bump forming apparatus according to claim 4, wherein the heating temperature of the second temperature controller is 170 to 230° C.

6. The solder bump forming apparatus according to claim 1, further comprising a heat insulator provided between the flux dispenser and the solder dispenser to block heat of the solder dispenser from being transferred to the flux dispenser.

7. The solder bump forming apparatus according to claim 1, further comprising a discharger discharging a flux vaporized on the processing substrate to the outside between the flux dispenser and the solder dispenser.

8. The solder bump forming apparatus according to claim 7, wherein the discharger includes a discharging line connected to a discharging space provided between the flux dispenser and the solder dispenser to suck the vaporized flux in the discharging space.

9. The solder bump forming apparatus according to claim 1, wherein the flux dispenser is provided integrally with the solder dispenser, and
the driver moves the flux dispenser and the solder dispenser so that the solder dispenser moves following the flux dispenser at the time of the soldering process.

10. A soldering facility comprising:
a substrate supporting apparatus supporting a processing substrate; and
a solder bump forming apparatus performing a soldering process on the processing substrate supported by the substrate supporting apparatus,
wherein the solder bump forming apparatus includes:
a flux dispenser dispensing a flux to the processing substrate;
a solder dispenser dispensing a solder to the processing substrate to which the flux is applied while moving following the flux dispenser; and
driver driving the flux dispenser and the solder dispenser.

11. The soldering facility according to claim 10, wherein the substrate supporting apparatus transfers the processing substrate so that a processing surface of the processing substrate is directed upwardly, and
the solder bump forming apparatus sequentially and downwardly dispenses the flux and the solder onto the processing substrate while moving horizontally over the substrate supporting apparatus.

12. The soldering facility according to claim 10, further comprising a protection pattern attaching device attaching a protection pattern selectively exposing an electrode pad formed on a circuit board to a processing surface of the circuit board.

13. The soldering facility according to claim 10, wherein the flux dispenser includes a first temperature controller heating the flux to a preset active temperature.

14. The soldering facility according to claim 10, wherein the solder dispenser includes a second temperature controller heating the solder to a preset temperature, and
a heating temperature of the second temperature controller is controlled so as to satisfy an active temperature of the flux in the flux dispenser as well as melt the solder.

15. The soldering facility according to claim 10, wherein the flux dispenser and the solder dispenser are disposed to be spaced apart from each other by a predetermined interval, and
a space between the flux dispenser and the solder dispenser is used as a discharging path discharging the flux volatilized on the processing substrate as well as preventing heat of the solder dispenser from being excessively transferred to the flux dispenser.

16. The soldering facility according to claim 10, wherein the flux dispenser is provided integrally with the solder dispenser, and
the driver moves the flux dispenser and the solder dispenser so that the solder dispenser moves following the flux dispenser at the time of the soldering process.

17. The soldering facility according to claim 11, wherein the flux dispenser includes a first temperature controller heating the flux to a preset active temperature.

18. The soldering facility according to claim 11, wherein the solder dispenser includes a second temperature controller heating the solder to a preset temperature, and
a heating temperature of the second temperature controller is controlled so as to satisfy an active temperature of the flux in the flux dispenser as well as melt the solder.

19. The soldering facility according to claim 11, wherein the flux dispenser and the solder dispenser are disposed to be spaced apart from each other by a predetermined interval, and
a space between the flux dispenser and the solder dispenser is used as a discharging path discharging the flux volatilized on the processing substrate as well as preventing heat of the solder dispenser from being excessively transferred to the flux dispenser.

20. The soldering facility according to claim 11, wherein the flux dispenser is provided integrally with the solder dispenser, and
the driver moves the flux dispenser and the solder dispenser so that the solder dispenser moves following the flux dispenser at the time of the soldering process.
